(19) United States
(12) Patent Application Publication
(10) Pub. No.: US 2018/0301891 A1
(43) Pub. Date: Oct. 18, 2018

(54) WINDOW CONTROL DEVICE AND METHOD FOR VEHICLE

(71) Applicants: HYUNDAI MOTOR COMPANY, SEOUL (KR); KIA MOTORS CORPORATION, SEOUL (KR); DY AUTO CORPORATION, ASAN-SI (KR)

(72) Inventors: Kyong Ho SHON, Seoul (KR); Wung Chul CHUNG, Seongnam-si (KR); Sug Woo SHIN, Suwon-si (KR); Dong Hun SON, Pohang-si (KR); Bo Sung JO, Seoul (KR)

(73) Assignees: HYUNDAI MOTOR COMPANY, SEOUL (KR); KIA MOTORS CORPORATION, SEOUL (KR); DY AUTO CORPORATION, ASAN-SI (KR)

(21) Appl. No.: 15/810,985

(22) Filed: Nov. 13, 2017

(30) Foreign Application Priority Data
Apr. 14, 2017 (KR) 10-2017-0048419

(51) Int. Cl. H02H 6/00; E05F 15/695; B60J 1/17

(52) U.S. Cl. CPC H02H 6/00; E05Y 2900/55; B60J 1/17; E05F 15/695

(57) ABSTRACT

The present disclosure provides a window control device and method for a vehicle. The window control device includes: a drive motor configured to open and close a window glass; a sensor configured to generate a pulse signal corresponding to a rotation of the drive motor; and a controller configured to repeatedly perform a safety function based on monitoring results of the pulse signal.

### CROSS-REFERENCE TO RELATED APPLICATION

The present application claims priority to and the benefit of Korean Patent Application No. 10-2017-0048419, filed on Apr. 14, 2017, which is incorporated herein by reference in its entirety.

### FIELD

The present disclosure relates to a window control device and method for a vehicle and, more particularly, to a technology for reliably performing a safety function in a power window system of a vehicle.

### BACKGROUND

The statements in this section merely provide background information related to the present disclosure and may not constitute prior art.

In general, a power window system mounted in a vehicle includes a switch and a drive motor. When a driver turns on the switch to operate the window, the system controls the drive motor to raise or lower the window glass of the vehicle according to the operation of the switch. Thus, the driver is able to easily open and close the window glass of the vehicle to a desired position with a simple operation of the switch.

Meanwhile, when the driver in the vehicle closes a rear door window glass using the switch, certain body parts of a rear seat passenger, such as fingers, arms, head, and neck, or an object may be occasionally trapped between the window glass and a door frame of the vehicle.

In this regard, a power window system has been developed to have a safety function. If the power window system senses an obstruction while raising the window glass, it is capable of automatically stopping raising the window glass or reversely lowering the window glass to protect the obstruction.

The power window system may include a ring magnet fixed to a rotating shaft of the drive motor and two hall sensors disposed around the ring magnet and having a phase difference of 90 degrees, and perform the safety function by detecting the speed (raising and lowering speed), position, and direction (raising and lowering direction) of the window glass on the basis of two pulse signals sensed by the two hall sensors.

In other words, the conventional power window system may determine whether or not the obstruction is trapped on the basis of the pulse signals generated by the two hall sensors, and may generate a control signal and transmit the control signal to the drive motor when it is determined that the obstruction is trapped.

After transmitting the control signal to the drive motor, such a conventional power window system does not monitor whether the safety function is normally performed, and thus the system performance may not be guaranteed.

In addition, the conventional power window system may not be suitable when the safety function is not normally performed.

### SUMMARY

An aspect of the present disclosure provides a window control device and method for a vehicle, which can improve reliability and performance of system by monitoring whether a safety function is normally performed on the basis of a pulse signal corresponding to a rotation of a drive motor and repeatedly performing the safety function when the safety function is not normally performed.

According to an aspect of the present disclosure, a window control device for a vehicle includes: a drive motor configured to open and close a window glass; a sensor configured to generate a pulse signal corresponding to a rotation of the drive motor; and a controller configured to repeatedly perform a safety function based on monitoring results of the pulse signal.

In performing the safety function, the controller may be configured to generate a control signal, wherein the control signal stops or lowers the window glass when the window glass is raised; and to transmit the control signal to the drive motor.

The controller may be configured to calculate a squeezing force applied to the window glass when it is determined based on the pulse signal that an obstruction is trapped in the window glass, and perform the safety function before the squeezing force reaches a first threshold.

The controller may be configured to recalculate the squeezing force at a point that a predetermined amount of time has elapsed, and perform the safety function again when the squeezing force recalculated by the controller is greater than or equal to a second threshold.

The controller may be configured to calculate the squeezing force based on revolutions per minute (RPM) of the drive motor.

The controller may be configured to determine that the obstruction is trapped in the window glass when a width of the pulse signal exceeds a reference value.

The controller may be configured to receive an operation signal from a switch, generate the control signal corresponding to the operation signal, and transmit the control signal to the drive motor.

The controller may be configured to perform the safety function when the window glass is raised.

The controller may be configured to perform the safety function when the window glass is positioned in a predetermined area.

The controller may include a safety logic for performing the safety function.

According to another aspect of the present disclosure, a window control method for a vehicle includes: generating, with a sensor, a pulse signal corresponding to a rotation of a drive motor, wherein the drive motor is configured to open and close a window glass; and performing, with a controller, a safety function repeatedly based on monitoring results of the pulse signal.

The safety function may include: generating a control signal, wherein the control signal stops or lowers the window glass when the window glass is raised, and transmitting the control signal to the drive motor.

Performing the safety function may include: calculating a squeezing force applied to the window glass when it is determined based on the pulse signal that an obstruction is trapped in the window glass; performing the safety function before the squeezing force reaches a first threshold; recalculating the squeezing force at a point that a predetermined amount of time has elapsed; and performing the safety function again when the squeezing force recalculated by the controller is greater than or equal to a second threshold.

Calculating the squeezing force may be based on revolutions per minute (RPM) of the drive motor.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates the configuration of a window control device for a vehicle;

FIG. 2 illustrates a safety function;

FIG. 3 illustrates the structure of a sensor;

FIG. 4 illustrates two pulse signals output from the sensor;

FIG. 5 illustrates a flowchart of a window control method for a vehicle; and

FIG. 6 illustrates a detailed flowchart of a window control method for a vehicle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, the speed of the window glass refers to a rate at which the window glass is open or closed, the direction of the window glass refers to a direction in which the window glass moves for opening or closing, and the position of the window glass refers to a degree of opening of the window glass.

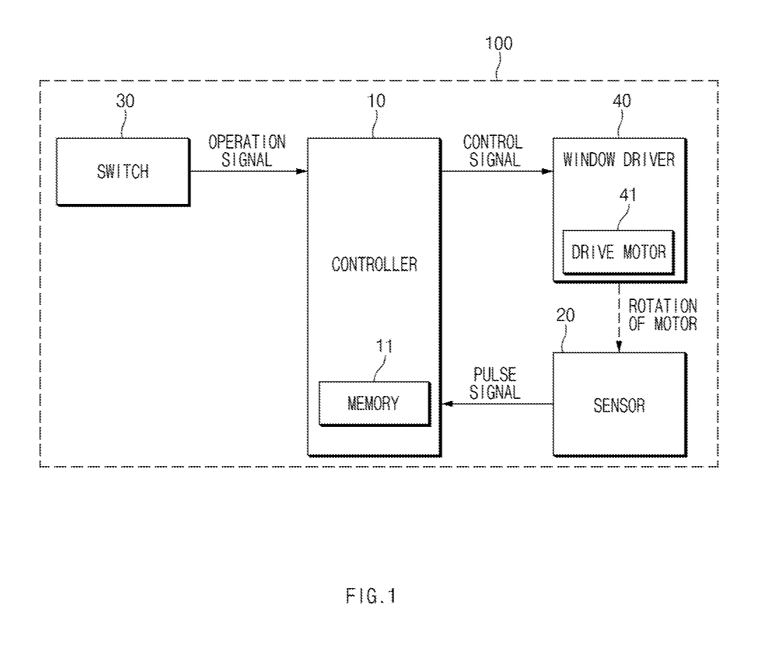

FIG. 1 illustrates the configuration of a window control device for a vehicle, in some forms of the present disclosure.

As illustrated in FIG. 1, the window control device 100 for a vehicle, in some forms of the present disclosure, includes a controller 10 and a sensor 20, and further includes a switch 30 and a window driver 40.

The switch 30 may serve to operate the window glass for raising or lowering the window glass according to a user's operation, and the window driver 40 may rotate a drive motor 41 according to a control signal from the controller 10, thereby serving to raise or lower the window glass. Hereinafter, the switch 30 and the window driver 40, which are general components, will be briefly described.

The switch 30 may generate an operation signal for instructing the raising, lowering, and stopping of the window glass according to the user's operation.

Meanwhile, the operation of the switch 30 includes a manual operation mode in which the window glass is open or closed while the switch is continuously operated by being continuously pulled or pressed, and an auto operation mode in which the window glass is fully open or closed by a single pulling or pressing operation of the switch. When the operation mode of the switch is divided as described above, the switch 30 may generate an operation signal depending on the auto operation mode or the manual operation mode according to the user's operation.

The window glass may be open or closed by the rotation of the drive motor 41. The window driver 40 includes the drive motor 41, and the drive motor 41 may be controlled according to a control signal generated by the controller 10. The control signal for controlling the drive motor 41 may follow the operation signal generated by the switch 30, that is, the operation signal generated according to the user's operation, during normal operation. However, if an obstruction is detected in the course of raising the window glass, the controller 10 may generate a control signal for the stop or reverse rotation of the drive motor 41 in order to perform a safety function and transmit the control signal to the drive motor 41.

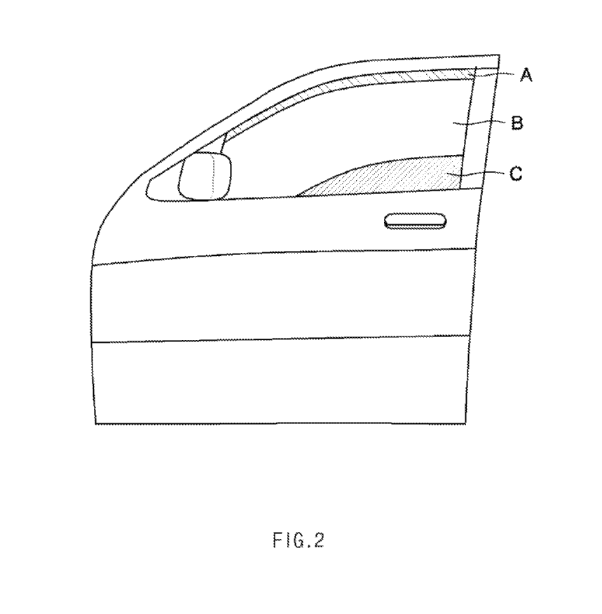

Hereinafter, the safety function will be described with reference to FIG. 2.

In general, the safety function refers to a function for automatically stopping or lowering (reversing) the window glass if an obstruction is detected (trapped) while the window glass is being raised.

As illustrated in FIG. 2, there are three areas depending on the position of the window glass. Area A and area C refer to an area where the safety function is inactivated, and area B refers to an area where the safety function is activated. In other words, area B refers to a safety area where the safety function is performed.

If an obstruction is detected while the window glass is being raised in area B, the safety function may be activated. Here, area B may be appropriately adjusted in consideration of various conditions such as the size, raising and lowering speed, and the like, of the window glass. In general, an area in a range of 4 mm-200 mm from the top of the window may be set as area B.

Since the safety function is inactivated in area A and area C, the window glass may not be stopped or lowered in those areas even if an obstruction is detected while the window glass is being raised, and the movement of the window glass may be controlled according to the user's operation of the switch.

Meanwhile, the sensor 20 includes a hall sensor disposed on a rotating shaft of the drive motor 41 that opens and closes the window glass, and the hall sensor may generate a pulse signal corresponding to the rotation of the drive motor 41.

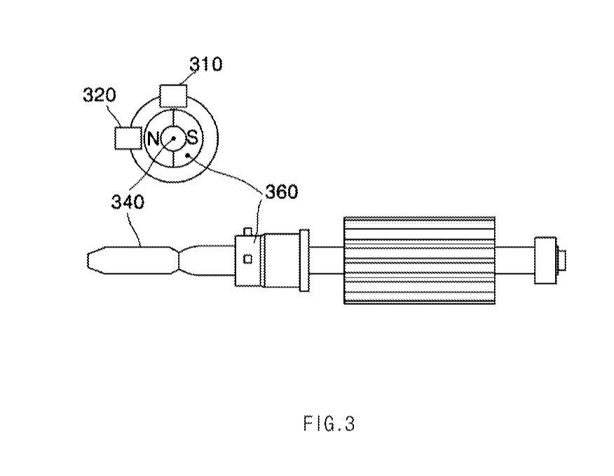

Hereinafter, the structure of the sensor 20 will be described with reference to FIG. 3.

As illustrated in FIG. 3, the sensor 20 used in some forms of the present disclosure includes a single ring magnet 360 and two hall sensors 310 and 320.

Since the ring magnet 360 is fixed to the rotating shaft 340 of the drive motor 41, the ring magnet 360 may also rotate as the drive motor 41 rotates. The two hall sensors 310 and 320 disposed around the ring magnet 360 may detect a change in magnetic field generated as the ring magnet 360 rotates, and may generate a pulse signal corresponding to the rotation of the ring magnet 360. Here, since the window glass also moves by the rotation of the drive motor 41, the pulse signal may correspond to the movement of the window glass.

Here, the hall sensors 310 and 320 may be disposed to have an arbitrary angle difference. For example, the two hall sensors 310 and 320 in FIG. 3 are disposed to have an angle difference of 90 degrees, and thus generate two pulse signals having a phase difference of 90 degrees. The generated two pulse signals may be used to determine whether an obstruction is trapped in the course of raising the window glass or whether the safety function has been normally performed.

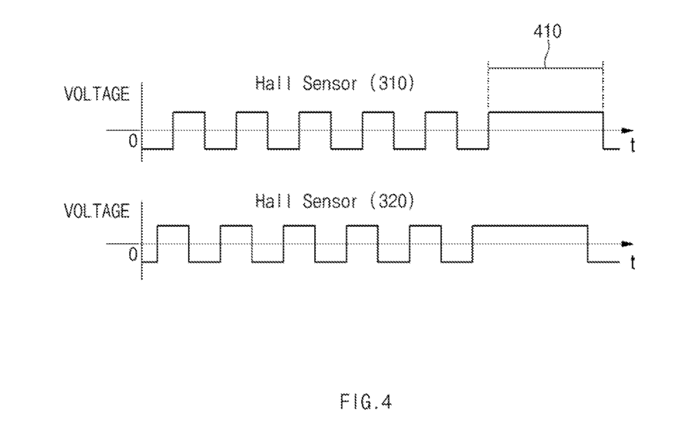

Hereinafter, two pulse signals output from the sensor 20 will be described with reference to FIG. 4.

In FIG. 4, a horizontal axis represents time, and a vertical axis represents a magnitude (voltage) of a pulse signal. Here, it can be seen that due to a change in magnetic field according to the rotation of the ring magnet 360, there is a phase difference of 90 degrees between a first pulse signal generated by the hall sensor 310 and a second pulse signal generated by the hall sensor 320.

An initial state of a pulse signal of which the period (interval) is constant means that the window glass is normally open or closed, and a portion 410 of the pulse signal of which the period becomes longer means that the speed of the window glass is slowed by an obstruction trapped in the course of raising the window glass. In other words, if the obstruction is trapped in the course of raising the window glass, the drive motor 41 may receive a load, and thus a width of the pulse signal may be increased.

Meanwhile, the controller 10 generally controls the aforementioned respective elements to perform the functions thereof normally. Here, the controller 10 may be a micro control unit (MCU), and store a safety logic in memory 11 to generate a control signal for performing a safety function.

In addition, the controller 10 may generate a control signal corresponding to an operation signal input through the switch 30 and control the drive motor 41 on the basis of the control signal during normal operation, but may control the drive motor 41 to perform a safety function when it is determined that an obstruction is trapped in the course of raising the window glass. In other words, the controller 10 may generate a control signal for performing a safety function and transmit the control signal to the drive motor 41. When the speed of the window glass is less than or equal to a threshold in the course of raising the window glass, the controller 10 may determine that the obstruction is trapped. Here, the speed of the window glass may be calculated by counting the pulse signal.

Furthermore, the controller 10 may perform the safety function on the basis of two pulse signals output from the sensor 20 during the operation of the drive motor 41. Here, a technique for calculating the speed, position, and direction of the window glass using the two pulse signals is generally known, and any known technique may be used.

In addition, the controller 10 may monitor whether the drive motor 41 normally stops or lowers the window glass, and retransmit a control signal for safety to the drive motor 41 unless the window glass is normally stopped or lowered. In other words, the controller 10 may perform the safety function again unless the safety function is normally performed.

Specifically, when it is determined that the obstruction is trapped in the course of raising the window glass, the controller 10 may calculate a squeezing force using the pulse signals generated by the sensor 20. Here, the squeezing force refers to a force (load) applied by an obstruction in a downward direction of the window glass.

For example, the squeezing force may be calculated using the revolutions per minute (RPM) of the drive motor 41 on the grounds that when the window glass is raised by 1 mm, a force of 10N is generated, and when the drive motor 41 rotates once, the window glass is raised by 2 mm. For example, when the RPM of the drive motor 41 is 5, a squeezing force of 100N is generated.

Thus, the controller 10 may calculate the squeezing force on the basis of the RPM of the drive motor 41. Here, the controller 10 may measure the RPM of the drive motor 41 using the pulse signals. In addition, the controller 10 may periodically calculate the squeezing force.

Then, the controller 10 may generate a control signal for safety before the squeezing force, which is calculated after the obstruction is detected, reaches a first threshold (for example, 100N), and transmit the generated control signal to the drive motor 41. In other words, the controller 10 may generate a control signal for stopping or lowering the window glass that is being raised and transmit the control signal to the drive motor 41. Here, the controller 10 may transmit the control signal to the drive motor 41, or may no longer calculate the squeezing force when the squeezing force exceeds the first threshold.

Then, the controller 10 may recalculate a squeezing force using the pulse signals generated by the sensor 20 after a critical time (for example, 0.1 second) has elapsed.

When the recalculated squeezing force is greater than or equal to a second threshold (for example, 190N), the controller 10 may determine that the safety function is not normally performed, generate a control signal for safety, and transmit the control signal to the drive motor 41. Here, when the recalculated squeezing force is less than the second threshold, the controller 10 may determine that the safety function is normally performed. In other words, the controller 10 may determine that the window glass is stopped or is being lowered.

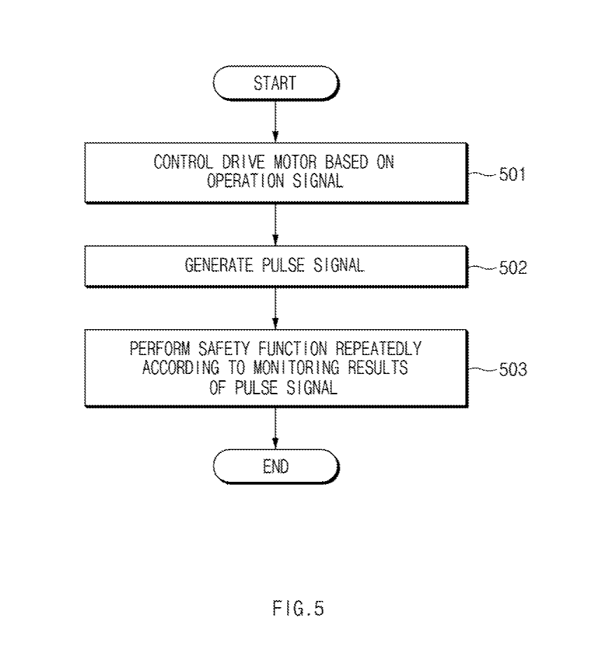

FIG. 5 illustrates a flowchart of a window control method for a vehicle, in some forms of the present disclosure.

First of all, the controller 10 may generate a control signal corresponding to an operation signal form the switch 30, and control the drive motor 41 on the basis of the control signal in operation 501.

Next, the sensor 20 may generate a pulse signal corresponding to the rotation of the drive motor 41 in operation 502.

Then, the controller 10 may monitor the pulse signal generated by the sensor 20, and repeatedly perform a safety function according to the monitoring results in operation 503.

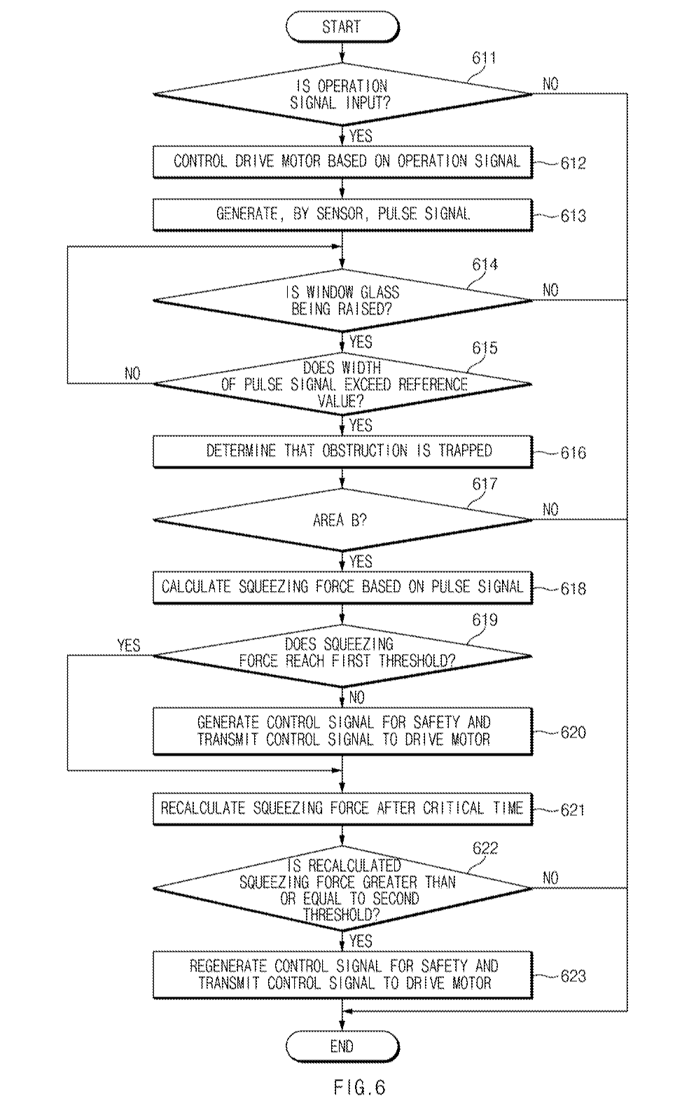

FIG. 6 illustrates a detailed flowchart of a window control method for a vehicle, in some forms of the present disclosure, and the following process may be performed by the controller 10.

First of all, it may be determined whether or not an operation signal is transmitted from the switch 30 in operation 611.

As a result of operation 611, when it is determined that the operation signal is not transmitted, the process may end.

As a result of operation 611, when it is determined that the operation signal is transmitted, a control signal corresponding to the operation signal may be generated and transmitted to the window driver 40 to control the drive motor 41 in operation 612.

Next, when the drive motor 41 is driven, the sensor 20 disposed on the rotating shaft of the drive motor 41 may generate a pulse signal corresponding to the rotation of the drive motor 41 in operation 613.

Thereafter, it may be determined whether the window glass is being raised or lowered on the basis of the pulse signal generated by the sensor 20 in operation 614.

As a result of operation 614, when it is determined that the window glass is being lowered, the process may end. In other words, when the window glass is being lowered, a safety function may not be performed.

As a result of operation 614, when it is determined that the window glass is being raised, it may be determined whether or not a width of the pulse signal exceeds a reference value in operation 615. Here, it may also be determined whether or not the speed of the window glass exceeds an average speed.

As a result of operation 615, when the width of the pulse signal exceeds the reference value, it may be determined that an obstruction is trapped in operation 616. Here, when the width of the pulse signal does not exceed the reference value, operation 614 may be performed.

Thereafter, it may be determined whether or not a current position of the window glass is in area B in operation 617. In other words, it may be determined whether or not the window glass is positioned in an area in which the safety function is activated.

As a result of operation 617, when it is determined that the window glass is positioned in area B, a squeezing force may be calculated on the basis of the pulse signal in operation 618. When it is determined that the window glass is not positioned in area B, the process may end. In addition, the controller 10 may calculate the squeezing force periodically.

Then, it may be determined whether or not the calculated squeezing force reaches a first threshold in operation 619.

As a result of operation 619, when it is determined that the calculated squeezing force does not reach the first threshold, a control signal for safety may be generated and transmitted to the drive motor 41 in operation 620. Here, as the squeezing force is increased over time, the control signal may be transmitted to the drive motor 41 before the squeezing force reaches the first threshold.

Thereafter, the controller 10 may recalculate a squeezing force using the pulse signal generated by the sensor 20 at a point in time at which a critical time has elapsed in operation 621.

Then, it may be determined whether or not the recalculated squeezing force is greater than or equal to a second threshold (for example, 190N) in operation 622.

As a result of operation 622, when the recalculated squeezing force is greater than or equal to the second threshold, it may be determined that the safety function is not normally performed, and a control signal for safety may be regenerated and transmitted to the drive motor 41 in operation 623.

As a result of operation 622, when the recalculated squeezing force is less than the second threshold, it may be determined that the safety function is normally performed, and thus the process may end. In other words, it may be determined that the window glass is being lowered, and the process may end.

As set forth above, the window control device and method for a vehicle, in some forms of the present disclosure, can improve reliability and performance of system by monitoring whether a safety function is normally performed on the basis of a pulse signal corresponding to the rotation of the drive motor and repeatedly performing the safety function when the safety function is not normally performed.

In addition, by performing the safety function, damages to an object and a vehicle as well as injuries to certain parts of a human body may be inhibited.

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A window control device for a vehicle, the window control device comprising:
a drive motor configured to open and close a window glass;
a sensor configured to generate a pulse signal corresponding to a rotation of the drive motor; and
a controller configured to:
determine whether a safety function is normally performed based on the pulse signal; and
reperform the safety function when it is determined that the safety function is not normally performed.

2. The window control device of claim 1, wherein, in performing the safety function, the controller is configured to:
generate a control signal, wherein the control signal stops or lowers the window glass when the window glass is raised; and
transmit the control signal to the drive motor.

3. The window control device of claim 2, wherein the controller is configured to:
when it is determined based on the pulse signal that an obstruction is trapped in the window glass, calculate a squeezing force applied to the window glass; and
perform the safety function before the squeezing force reaches a first threshold.

4. The window control device of claim 3, wherein the controller is configured to:
recalculate the squeezing force at a point that a predetermined amount of time has elapsed; and
when the squeezing force recalculated by the controller is greater than or equal to a second threshold, perform the safety function again.

5. The window control device of claim 3, wherein the controller is configured to calculate the squeezing force based on revolutions per minute (RPM) of the drive motor.

6. The window control device of claim 3, wherein, when a width of the pulse signal exceeds a reference value, the controller is configured to determine that the obstruction is trapped in the window glass.

7. The window control device of claim 1, wherein the controller is configured to:
receive an operation signal from a switch;
generate the control signal corresponding to the operation signal; and
transmit the control signal to the drive motor.

8. The window control device of claim 1, wherein, when the window glass is raised, the controller is configured to perform the safety function.

9. The window control device of claim 1, wherein, when the window glass is positioned in a predetermined area, the controller is configured to perform the safety function.

10. The window control device of claim 1, wherein the controller includes a safety logic for performing the safety function.

11. A window control method for a vehicle, the window control method comprising:
generating, with a sensor, a pulse signal corresponding to a rotation of a drive motor, wherein the drive motor is configured to open and close a window glass;
determining, with a controller, whether a safety function is normally performed based on the pulse signal; and
when it is determined that the safety function is not normally performed, reperforming, with the controller, the safety function.

12. The window control method of claim 11, wherein performing the safety function comprises:
generating a control signal, wherein the control signal stops or lowers the window glass when the window glass is raised; and
transmitting the control signal to the drive motor.

13. The window control method of claim 11, wherein performing the safety function comprises:
when it is determined based on the pulse signal that an obstruction is trapped in the window glass, calculating a squeezing force applied to the window glass;
performing the safety function before the squeezing force reaches a first threshold;
recalculating the squeezing force at a point that a predetermined amount of time has elapsed; and
performing the safety function again when the squeezing force recalculated by the controller is greater than or equal to a second threshold.

14. The window control method of claim 13, wherein calculating the squeezing force is based on revolutions per minute (RPM) of the drive motor.

15. The window control method of claim 13, wherein, when a width of the pulse signal exceeds a reference value, determining that the obstruction is trapped in the window glass.

16. The window control method of claim 11, further comprising:
receiving an operation signal from a switch;
generating a control signal corresponding to the operation signal; and
transmitting the control signal to the drive motor to rotate the drive motor.

17. The window control method of claim 11, wherein, when the window glass is raised, performing the safety function.

18. The window control method of claim 11, wherein, when the window glass is positioned in a predetermined area, performing the safety function.
